(19) United States
(12) Patent Application Publication
(10) Pub. No.: US 2010/0306300 A1
(43) Pub. Date: Dec. 2, 2010

(54) Sparse Matrix Padding

(75) Inventors: Jizhu Lu, Bellevue, WA (US); Laurent Visconti, Bainbridge Island, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/474,882

(22) Filed: May 29, 2009

(51) Int. Cl. G06F 7/32

(52) U.S. Cl. 708/520

(57) ABSTRACT

Zero elements are added to respective lines (e.g., rows/columns) of a sparse matrix. The added zero elements increase the number of elements in the respective lines to be a multiple of a predetermined even number “n” (e.g., 2, 4, 8, etc.), based upon an n-fold unrolling loop, where n=2, 4, 8, etc. By forming a sparse matrix having lines (e.g., rows or columns) that are multiples of the predetermined number “n”, the n-fold unrolling loop thereby acts upon a predetermined number of elements in respective iterations, avoiding unnecessarily costly operations (e.g., additional loop unrolling code) on remainder non-zero elements (e.g. remainder row/column elements not within an n-fold unrolling loop) left in a row or column after unrolling. This improves the efficiency of sparse matrix linear algebra solvers and key sparse linear algebra kernels (e.g., SPMV) thereby improving the overall performance of a computer (e.g., running an application).

### BACKGROUND

A sparse matrix is a matrix comprising entries having mostly zero elements (e.g., “0”). Sparse matrices efficiently store data by relying upon the basic idea of merely storing non-zero elements as opposed to all elements, thereby providing for large memory savings and performance improvements (e.g., by operating upon a subset of matrix elements) in comparison to approaches which store all data (e.g., zero elements and non-zero elements).

Because of such advantages, sparse matrices are widely used and play a valuable role in many computer applications. For example, the world wide web, social networks, scientific computing applications, and scheduling applications, often rely upon storing data in sparse matrices and operating upon the data stored in the sparse matrices.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, a sparse matrix storage format is provided herein that offers improved processing performance. More particularly, one or more methods and/or systems of padding lines (e.g., rows or columns) of a sparse matrix (e.g., stored as a value vector, a first index vector, and a second index vector) with zero elements are disclosed so that the total number of elements in respective lines (e.g., rows or columns) allows for enhanced processing performance.

In one example, zero elements (e.g., 0's) are added to respective lines (e.g., rows or columns) of a sparse matrix. The added zero elements increase the number of elements in the respective lines to be a multiple of a predetermined even number “n”, based upon an n-fold unrolling loop, where n=2, 4, or 8, etc. By forming a sparse matrix having lines that are multiples of the predetermined even number, the n-fold unrolling loop acts upon a multiple of the predetermined even number “n” of elements, thereby avoiding unnecessarily costly operations (e.g., additional loop unrolling code) on remainder non-zero elements (e.g. remainder row/column elements not within an n-fold unrolling loop) left in a row/column after unrolling. This improves the efficiency of sparse matrix linear algebra solvers and key sparse linear algebra kernels (e.g., Sparse matrix vector multiply), for example, thereby improving the overall performance of a computer (e.g., running an application).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 illustrates an exemplary sparse matrix and an associated CSR sparse matrix file storage format.

FIG. 2 illustrates an exemplary communication diagram showing code unrolling by a 4-fold unrolling loop.

FIG. 3 illustrates a flow chart illustrating an exemplary method for padding a sparse matrix.

FIG. 4 illustrates an exemplary sparse matrix and an associated Padded CSR (PCSR) sparse matrix file storage format.

FIG. 5 illustrates an exemplary sparse matrix and an associated Padded CSC (PCSC) sparse matrix file storage format.

FIG. 6 illustrates a flow chart illustrating an exemplary method for padding a sparse matrix utilizing a CSR sparse matrix storage format.

FIG. 7 illustrates a flow chart illustrating an exemplary method for padding a sparse matrix utilizing a CSC sparse matrix storage format.

FIG. 8 illustrates a block diagram of an exemplary computer system configured to implement a numeric routine upon a padded sparse matrix as provided herein.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Sparse matrices can be used in a wide variety of computer applications. Often sparse matrices are used to store data in a highly efficient manner. For example, many web applications rely upon sparse matrices to store data (e.g., user behavioral data). The data stored in a sparse matrix can typically be manipulated by computer applications configured to analyze the stored data using numeric routines (e.g., sparse matrix linear algebra solvers, sparse linear algebra kernels comprising sparse vector matrix multiply).

The numeric routines are used very often (e.g., hundreds of thousands of times) during a process and therefore can lead to low performance if they are not efficient. To improve performance, by limiting a number of code stall spots (e.g., at the end of a code loop iteration), loop unrolling may be used. Loop unrolling attempts to increase an application's performance of code loops (e.g., if then loops, for loops, etc.). However, in sparse matrices, since merely the non-zero elements are stored, it is difficult to efficiently perform loop unrolling since the number of elements in a respective row or column of a sparse matrix is unknown. This results in additional processing of remainder elements of a row of column. Accordingly, a file storage format described herein offers a file format which allows for improved performance.

Among other things, a padded sparse matrix file storage format is provided herein that offers improved processing performance. More particularly, one or more methods and/or systems of padding lines (e.g., rows or columns) of a sparse matrix (e.g., stored as a value vector, a first index vector, and a second index vector) with zero elements are provided so that the total number of elements in respective lines (e.g., rows or columns) allows for enhanced processing performance.

In one example, zero elements (e.g., 0's) are added to respective lines (e.g., rows or columns) of a sparse matrix. The added zero elements increase the number of elements in the respective lines to be a multiple of a predetermined even number “n”, based upon an n-fold unrolling loop, where n=2, 4, or 8, etc. By forming a sparse matrix having lines that are multiples of the predetermined even number, the n-fold unrolling loop thereby acts upon a multiple of the predetermined even number “n” of elements, thereby avoiding unnecessarily costly operations (e.g., additional loop unrolling code) on remainder non-zero elements (e.g. remainder row elements not within an n-fold unrolling loop) left in a row after unrolling. This improves the efficiency of sparse matrix linear algebra solvers and key sparse linear algebra kernels (e.g., Sparse matrix vector multiply), for example, thereby improving the overall performance of a computer (e.g., running an application).

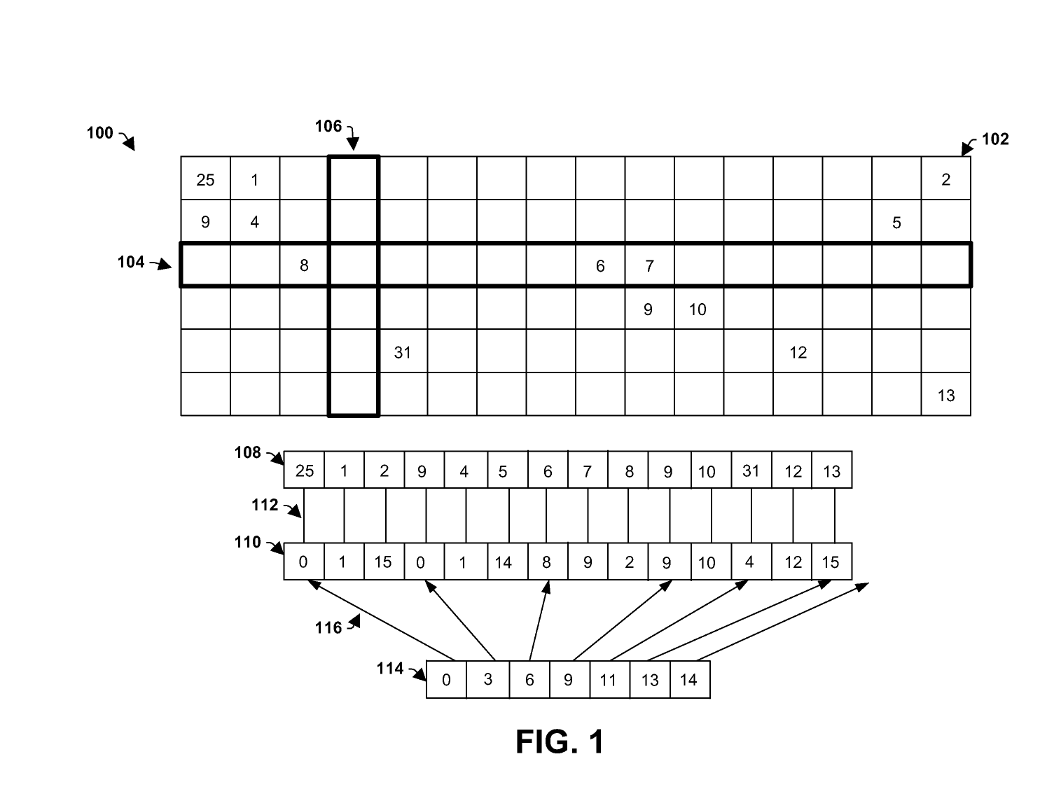

FIG. 1 illustrates an exemplary sparse matrix 102 and an associated CSR sparse matrix file storage format (comprising 108, 110, and 114). The sparse matrix and associated file storage format are provided to aid in understanding of the padded sparse matrix provided herein. Although FIG. 1 illustrates a sparse matrix with a CSR sparse matrix storage format, it will be appreciated that the method and system provided herein may also be applied to other sparse matrix file formats (e.g., CSC, BCSR, BCSC, etc.) having a similar structure. That is, the disclosure herein is not meant to be limited to/by the particular examples illustrated.

As shown in FIG. 1, the sparse matrix 102 has a low density of non-zero elements (e.g., comprises mostly zero elements). The sparse matrix 102 comprises rows 104 and columns 106. Typically, sparse matrices can be stored in a file format which does not allocate memory for zero-elements (e.g., CSR, CSC, etc.), thereby saving memory resources and improving processing performance. FIG. 1 illustrates one exemplary file format, a CSR sparse matrix file storage format (CSR file format) comprising a value vector 108, a first index vector 110, and a second index vector 114. In a CSR file format, the value vector 108 is associated with the sparse matrix 102 and may be configured to comprise the non-zero elements (e.g., values) of the sparse matrix 102 arranged in contiguous locations of the value vector. As illustrated in FIG. 1, the value vector 108 comprises a vector (e.g., 1×n matrix) having the non-zero elements of the sparse matrix 102. For example, the value vector comprises the sparse matrix elements of 25, 1, 2, 9, 4, etc.

The location of the value vector elements (e.g., 25, 1, 9, etc.) in the sparse matrix 102 may be stored in two index vectors, 110 and 114. In other words, the index vectors (e.g., a row index vector and a column index vector) cumulatively provide a location within the sparse matrix 102 for elements of the value vector 108 in the form of a row value and a column value. For example, as illustrated in FIG. 1 a column index vector 110 comprises 14 elements and a row index vector 114 comprises 7 elements. Respective elements of the column index vector 110 may be associated with an element of the value vector 108 by way of a pointer 112, thereby providing a column coordinate for the associated element of the value vector 108. Respective elements of the row index vector 114 are also associated with an element of the value vector 108 by way of a pointer 116, thereby providing a row coordinate for respective elements of the value vector 108. For example, element 25 of the value vector 108 is associated with a column value of 0 and a row value of 0, therefore indicating that the sparse matrix 102 has a value of 25 in its 0^{th} row and its 0^{th} column.

Accordingly, file formats such as the CSR, CSC, etc. file formats allow for the elements of a sparse matrix to be stored by three vectors (e.g., a value vector, a row index vector, and a column index vector), thereby reducing the size of the memory needed. It will be appreciated that since a sparse matrix may be stored as three different vectors, that referring herein to the padding (e.g., adding zero elements) of sparse matrix lines is equivalent to referring to padding a value vector and a first index vector. For example, in FIG. 1, padding the sparse matrix 102 is equivalent to padding the value vector 108 and row index vector 110.

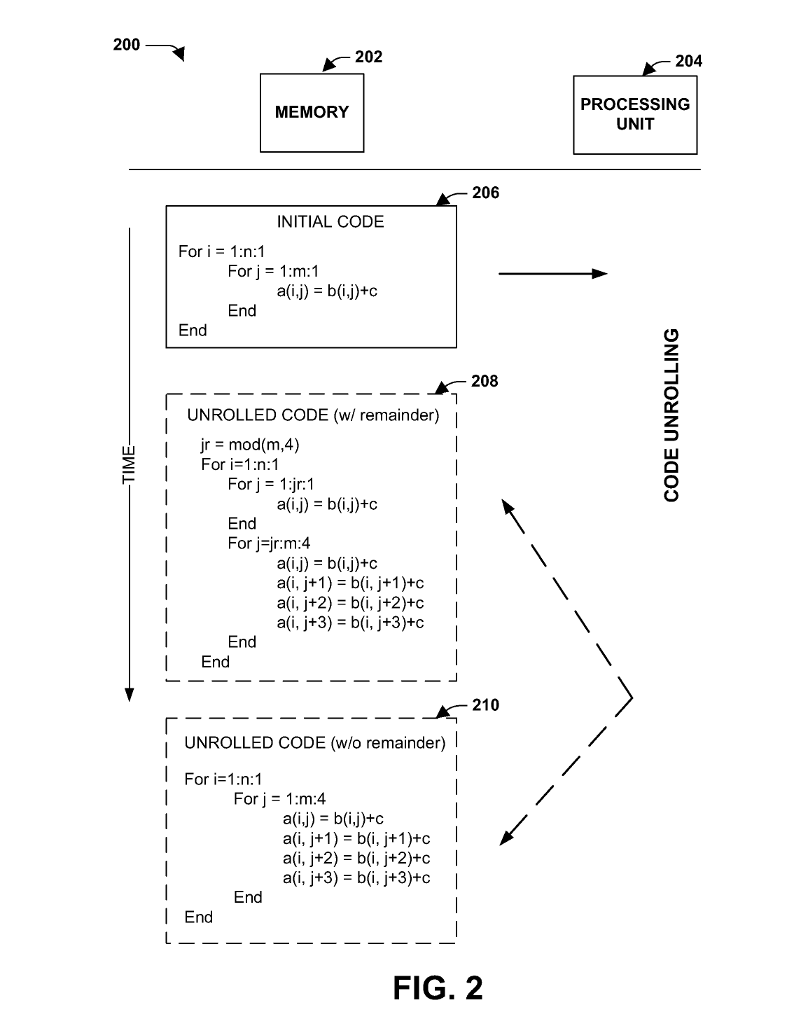

Applications utilizing sparse matrices may often rely upon loop unrolling to improve data access and performance of numeric routines (e.g., Sparse matrix linear algebra solvers, Sparse matrix vector multipliers). FIG. 2 illustrates exemplary communication diagram showing code unrolling by a 4-fold unrolling loop. An initial code 206 (e.g., a code that has not been unrolled) is stored in a memory location 202 and may have an inner nested loop (e.g., the “j” For loop) configured to iterate over a row/column index vector and an outer nested loop (e.g., the “i” For loop) configured to iterate over a column/row index vector. In the initial code 206, the notation “For j=1:m:1” means the initial value of j is equal to 1, the upper bound of j is equal to m, and the step of j for respective iterations of the loop is equal to 1. For example, during respective iterations of the loop (e.g., the j For loop), j will be 1, 2, 3, 4, . . . , etc. As can be seen in code 206, the inner nested loop performs one operation during a respective iteration of the loop.

To improve performance, the code may be operated on by a processing unit 204 (e.g., a compiler, a dynamic program) which, by performing loop unrolling, may unroll the inner nested loop to reduce the number of times that the loop is implemented. FIG. 2 illustrates a 4-fold unrolling without knowledge of m at 208 and a 4-fold unrolling as provided herein at 210.

To perform a 4-fold loop unrolling without knowledge of whether the m is multiple of 4, the code may be unrolled in a manner that facilitates correct computing results. Since the upper boundaries of the loop are not known, a remainder, jr, is initially calculated (e.g., jr=mod(m,4)) and then processed for correct computing results after loop unrolling (e.g., the remainder is proceeded and leaving a number of remaining, unprocessed elements that is a multiple of 4). The unrolled code 208 may increase an application's performance by decreasing costly downtime, however the loop unrolling may still perform an extra action beyond the unrolling making it is less efficient than possible (e.g., the loop body of “For j=1;jr:1; a(i,j)=b(i,j)+c; End” may or may not be executed during respective iterations of loop “n”, however the remainder is calculated in respective iterations of loop n to facilitate obtaining correct computing results).

In contrast, the method of sparse matrix padding provided herein will provide that m is a multiple of an even number n (e.g., n=4), thereby allowing a simplified n-fold (e.g., 4-fold) loop unrolling. In other words, by providing that m is a multiple of an even number n, the method will remove extra code used to calculate and process the remainder. Code 210 illustrates code which may operate on a padded matrix (e.g., having padded columns and/or rows that are a multiple of m) as provided herein. This simplified code does not process remainder elements thereby offering a performance advantage to code loop unrolling.

That is, by inserting zero elements in a value vector and a first index vector, configured to store a sparse matrix, code for processing the sparse matrix may be simplified (e.g., by removing code that determines remainder elements in the value vector after loop unrolling) to improve performance. Therefore, a predetermined even number “n” may be set equal to or greater than an n-fold loop unrolling. For example, code with 2-fold loop unrolling can work correctly without remainder elements on a sparse matrix which has been padded to multiples of 2 or 4 or 8 elements in respective lines. Similarly, code with 4-fold loop unrolling can work correctly without remainder elements on a sparse matrix which has been padded to multiples of 4 or 8 elements in respective lines, but may get wrong computing results on a sparse matrix which has been padded to multiples of 2 elements in each line, for example.

In one particular example, the value of “n” can be chosen through experiments. For example, if on average a code gets improved performance when an 8-fold loop unrolling is performed, then n can be chosen to be equal to 8, and the code working on the sparse matrix can be written in 8-fold loop unrolling format (e.g., but without the code for processing the remainder elements). For such code to work correctly, sparse matrices are converted from standard CSR format to padded CSR (PCSR) format by inserting zero elements to respective lines (e.g., rows or columns) so that respective lines contain a number multiple of 8 elements. In other words, if a sparse matrix has a number of elements in respective lines (e.g., row or column) that are a multiple of 8, then code operating on the matrix can be written in 8-fold loop unrolling format, thereby inhibiting the code from processing the remainder elements but still obtaining correct computing results.

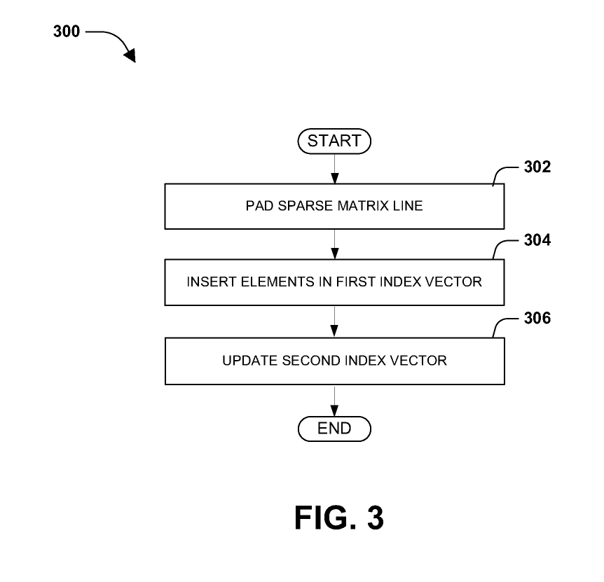

FIG. 3 illustrates a flow chart of an exemplary method 300 for padding a sparse matrix. More particularly, exemplary method 300 relates to a method of padding compressed storage files for sparse matrices by inserting zero elements at positions not occupied by non-zero elements in respective lines (e.g., rows or columns) of a sparse matrix so that data within the sparse matrix can be more efficiently accessed, thereby leading to improved processing performance.

At 302 a line of a sparse matrix is padded by adding zero elements at 302. More particularly, the zero elements are added to an associated value vector typically containing non-zero elements (e.g., the padded value vector also contains the added zero elements contained in the original sparse matrix). The zero elements make the value vector comprise a multiple of an even number of elements (e.g., although this may also be thought of as padding the sparse matrix since padding zero elements to the value vector is merely choosing some zero elements from the sparse matrix and adding them into the value vector). The zero elements may be added to at the positions not occupied by non-zero elements and provide for a number of line elements (e.g., non-zero and zero elements) that are divisible by the predetermined unrolling-fold number. For example, a line having 17 elements and a predetermined unrolling-fold number of 4 would add three zero elements to the line to form a line having 20 elements (and therefore divisible by the predetermined number 4). That is, padding, etc. as used herein is not intended merely mean added to the end of a line, but rather adding zero elements anywhere.

In one example, the predetermined even number is determined from how many fold loop unrolling acts are to be performed, which can be determined through empirical testing (e.g., experiments). For example, if using 2-fold instead of 4-fold or 8-fold loop unrolling results in improved performance, then a 2-fold loop unrolling in code may be performed, and the predetermined even number “n” is equal to 2. This would cause line padding to result in a total number of elements in the value vector and an associated index vector to be a multiple of 2, so that the code processing the possible single remaining element in the value vector after 2-fold loop unrolling can be removed to get improved performance. Alternatively, if an 8-fold loop unrolling is performed, the number of elements in the respective lines is a multiple of 8, and accordingly the predetermined even number “n” is equal to 8. Therefore, in general, for an n-fold loop unrolling in code, “the predetermined even number” is equal to “n”.

Furthermore, it will be appreciated that respective lines of the matrix may be padded differently to obtain a multiple of a predetermined even number, depending on the existing non-zero elements present. For example, a line comprising 3 non-zero elements may be padded differently (e.g., a different number of zero elements may be added) than a line comprising 5 non-zero elements.

Moreover, depending upon the file storage format the line of a sparse matrix may comprise a sparse matrix row or a sparse matrix column. For example, the zero elements may be added to the rows of a sparse matrix (e.g., elements may be added to a value vector and a column index vector) for a CSR file format or they may be added to the columns of a sparse matrix (e.g., elements may be added to a value vector and a row index vector) for a CSC file format.

Elements are inserted in a first index vector at 304 to account for the newly inserted zero elements. The elements inserted into the first index vector (e.g., column index vector or row index vector) point to a column or row location (in the sparse matrix) of respective zero elements that have been added into the value vector. Therefore, the number of elements inserted into the first index vector is equal to the number of zero elements inserted into the sparse matrix.

At 306 a second index vector is updated to account for the newly inserted zero elements. The second index vector may comprise elements which point to a new starting and/or ending address of updated lines in the sparse matrix. In one example, the second index vector may contain one element more than the number of lines in the sparse matrix, which points to a position one element further from the last element of the last line of the sparse matrix or points to a position from one up to n−1 elements further from the last element of the last line of the sparse matrix after n-fold loop unrolling. For example, after an 8-fold loop unrolling, the last element of the second index vector could point to a position 1, 2, 3, 4, 5, 6 or 7 elements further from the last element of the last line for the a piece of code to work properly.

Furthermore, it will be appreciated that in the example, respective elements in the second index vector may point to the starting address of lines (e.g., rows or columns) in the sparse matrix, or the respective elements may point to the ending address of lines (e.g., rows or columns) in sparse matrix instead. It will be appreciated that, in general, the form of the second index vector may vary when used in non standard CSR or CSC formats, and the method provided herein is applicable regardless of the format of the second index vector. The second index vectors illustrated throughout the detailed description are only examples of possible formats and are not intended to be interpreted in a limiting manner.

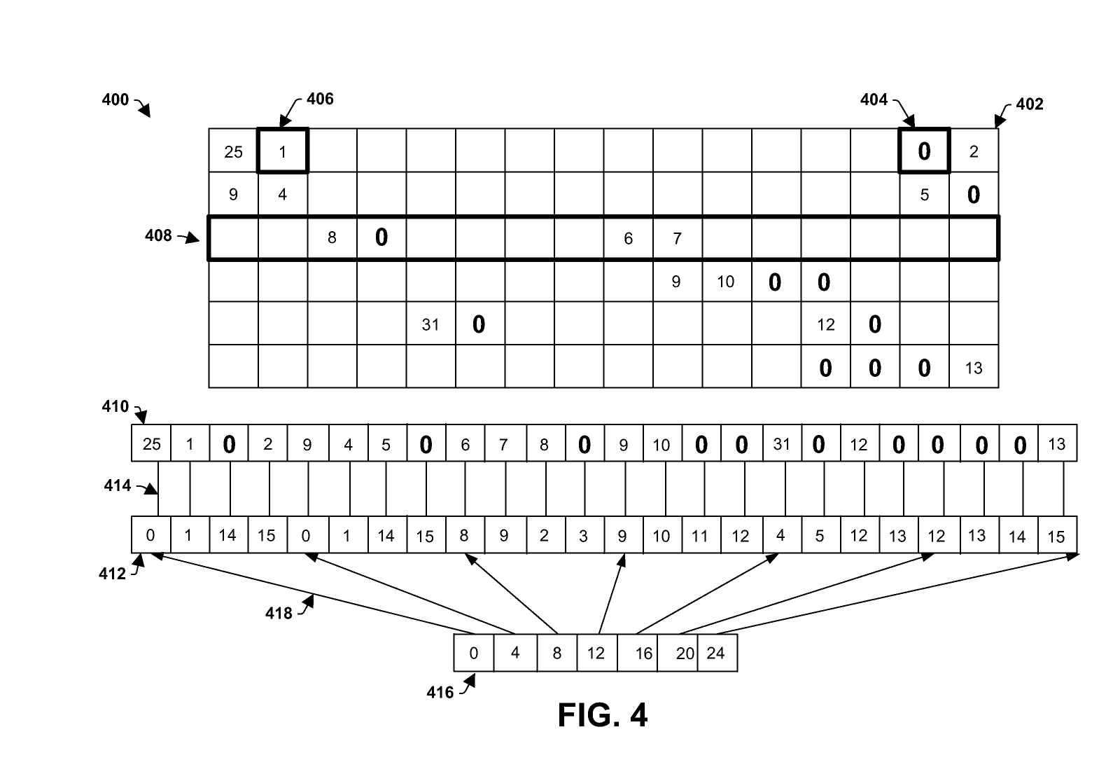

FIG. 4 illustrates an exemplary padded sparse matrix 402 and an associated Padded CSR (PCSR) sparse matrix file storage format (comprising 410, 412, and 416). It will be appreciated that advantages of the padded CSR may be more fully understood when taken in comparison to the non-padded CSR illustrated in FIG. 1.

As illustrated in FIG. 4, zero elements 404 have been added to the sparse matrix 402 in addition to the non-zero elements 406. The additional zero elements 404 increase the number of elements in respective rows 408 of the sparse matrix 402 to be a multiple of a predetermined even number “n”. For example, the added zero elements 404 increase the total number of elements (e.g., zero elements and non-zero elements) in respective rows 408 of the sparse matrix 402 to 4 elements (e.g., in the first row a zero element is added to the three non-zero elements) causing the total number of elements in respective rows 408 to be even multiple of a predetermined number equal to 4.

It will be appreciated that the addition of zero elements 404 into the sparse matrix 402 can be performed independent of the format of the existing non-zero elements 406 of a row. Instead, the zero elements 404 may be added based upon the total number of elements in a row, thereby increasing the number of elements in the respective rows to be a multiple of a predetermined even number “n” when an n-fold loop unrolling is performed.

Furthermore, although the exemplary PCSR of FIG. 4 is illustrated as being configured to store integer values, it will be appreciated that the PSCR is not limited to a specific data type. For example, the data types of the elements of a sparse matrix may comprise integers, single floating points, double floating points, complex, or other data types. In other words, the padded sparse matrix provided herein may store different data type elements in the sparse matrix as long as the padded elements do not change the computing results of the operations to be performed (e.g., reduce the advantages of simplified loop unrolling).

The addition of zero elements 404 also affects an associated value vector 410, a column index vector 412, and a row index vector 416, collectively configured to store the sparse matrix 402. For example, the value vector 410 associated with the sparse matrix 402 may be configured to comprise the zero elements 404 that have been inserted into the sparse matrix 402. The column index vector 412 may also be configured to comprise additional elements (e.g., which comprise the column number of the zero elements added to the value vector 410), while the row index vector 416 may be updated to account for the additional elements that have been added to the column index vector 412 and the value vector 410.

There is no restriction regarding where the newly added zero elements may be arranged. For example, the newly added zero elements of the value vector 410 may be arranged at any positions (e.g., at gaps between the lines) other than those positions previously occupied by non-zero elements in respective rows. However, as shown in FIG. 4, the zero elements of the value vector 410 may be arranged adjacent to existing non-zero elements for the purpose of improving performance. Additionally, the insertion of zero elements should usually not change the dimension size of the original sparse matrix. For example, In FIG. 4, the dimension size of the original sparse matrix is b 6×16, so after insertion of zero elements, the dimension size of the sparse matrix may still be 6×16. If the matrix size changes other objects which interacts with this sparse matrix (e.g., multiplying the sparse matrix using a matrix-vector multiplication) may also have to change.

It will be appreciated that the additional zero elements 404 may increase the size of the value vector 410. For example, for a sparse matrix having m rows and n columns (e.g., an m×n matrix) with a “k” fold loop unrolling, the length of the value vector may be increased by a maximum of (k−1)×m elements over a standard CSR format. In FIG. 4, the size of the value vector 410 is increased by 10 elements.

As shown in FIG. 4, the row index vector 416 has been updated to account for the additional elements that have been added to the value vector 410 and the column index vector 412 (e.g., to point to the new starting and/or ending address of the updated rows in the value vector). As illustrated in FIG. 4, the row index vector elements point 418 to every fourth element of the value vector as a staring point of a new row. In other words, the row index is configured such that respective rows in the value vector comprise a number of elements that is equal to a multiple of 4 (e.g., the number of elements in respective rows equals u×4, where u=1, 2, 3, . . . ).

The padded sparse matrix shown in FIG. 4 allows for improved performance due to enhanced loop unrolling. For example, a 4-fold loop unrolling will result in a loop of code which acts upon a predetermined number of elements in respective rows (e.g., a loop of a code may process the elements of one row of the sparse matrix), thereby avoiding unnecessarily costly operations on remainder non-zero elements (e.g. remainder row elements not within a 4-fold unrolling loop) left in a row after unrolling.

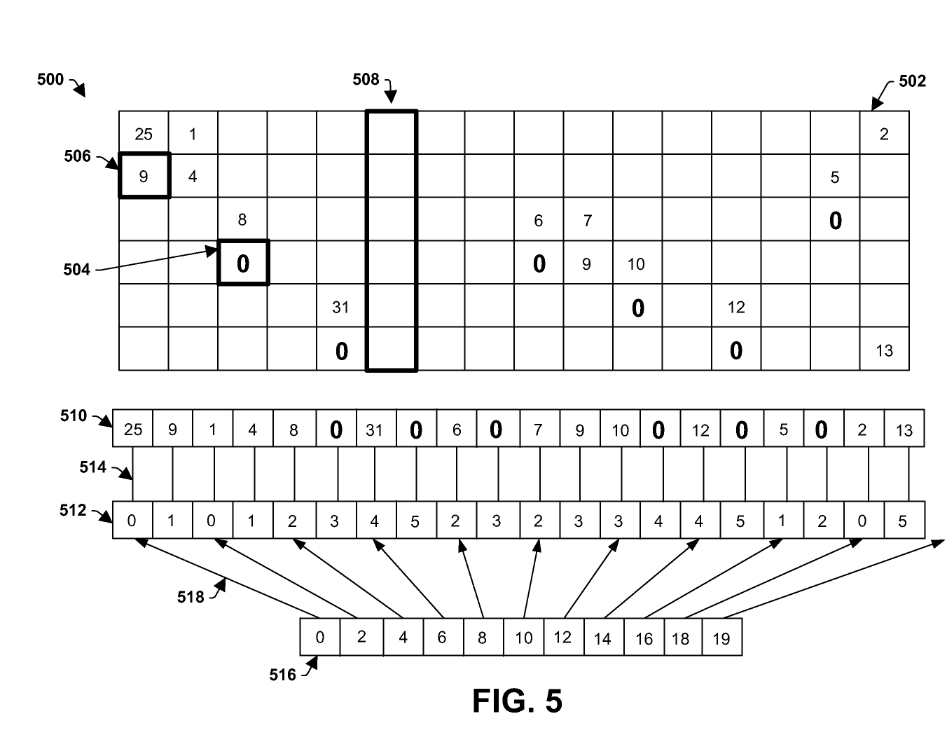

FIG. 5 illustrates an exemplary padded sparse matrix 502 and an associated Padded CSC (PCSC) sparse matrix file storage format (comprising 510, 512, and 516). In FIG. 5, zero elements 504 have been added to the sparse matrix 502 in addition to the non-zero elements 506 to increase the number of elements in respective columns 508 of the sparse matrix 502 to be an even multiple of a predetermined unrolling-fold number 2. For example, in the third column (e.g., column “2”) a zero element is added below of the non-zero element of “8” causing the total number of elements in the column to be even multiple of a predetermined number (e.g., 2)

As with the CSR sparse matrix, the addition of zero elements 504 into the sparse matrix 502 may be performed independent of the format of the existing non-zero elements 506 of a column 508. Instead, the zero elements 504 are added to increase the number of elements in the respective columns 508 to be a multiple of a predetermined even number “n” that may be based upon an n-fold loop unrolling function (e.g., the predetermined even number may be equal to n).

The addition of zero elements affects the associated value vector 510, row index vector 512, and column index vector 516, collectively configured to store the sparse matrix 502. For example, the value vector 510 associated with the sparse matrix 502 may be configured to comprise the zero elements 504 that have been inserted into the sparse matrix 502 among the non-zero elements in respective columns, while the row index vector 512 may be configured to comprise additional elements relating to the zero elements added to the value vector 510 and the column index vector 516 may be updated to account for the additional elements that have been added to the row index vector 512 and the value vector 510 (e.g., as illustrated in FIG. 5 the column index vector elements point to every second vector element as the staring point of a new column).

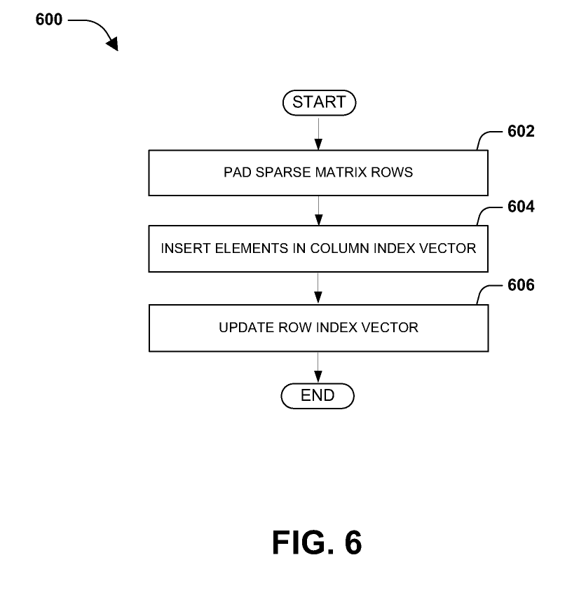

FIG. 6 illustrates a flow chart illustrating an exemplary method 600 padding a sparse matrix utilizing a CSR sparse matrix file storage format. More particularly, the method 600 is an example of method 200 applied to a sparse matrix using a CSR file storage format. At 602 a row of the sparse matrix is padded by adding zero elements. Elements are inserted in a column index vector at 604 to account for the newly inserted zero elements. At 606 a row index vector is updated to account for the newly inserted zero elements.

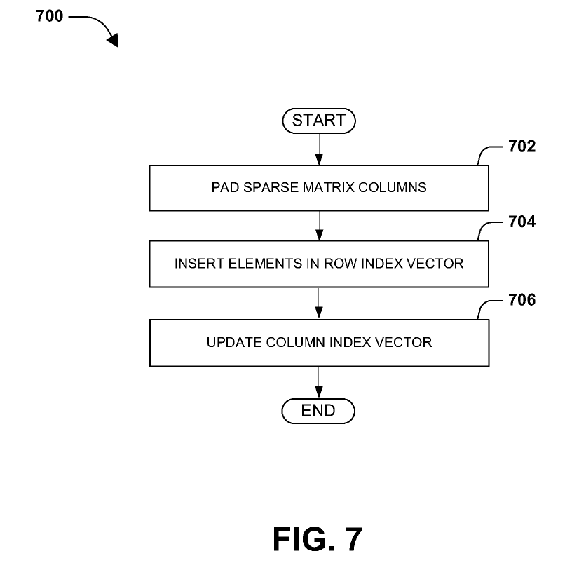

FIG. 7 illustrates a flow chart illustrating an exemplary method 700 padding a sparse matrix utilizing a CSC sparse matrix file storage format. More particularly, the method 700 is an example of method 200 applied to a sparse matrix using a CSC file storage format. At 702 a column of the sparse matrix is padded by adding zero elements. Elements are inserted in a row index vector at 704 to account for the newly inserted zero elements. At 706 a column index vector is updated to account for the newly inserted zero elements.

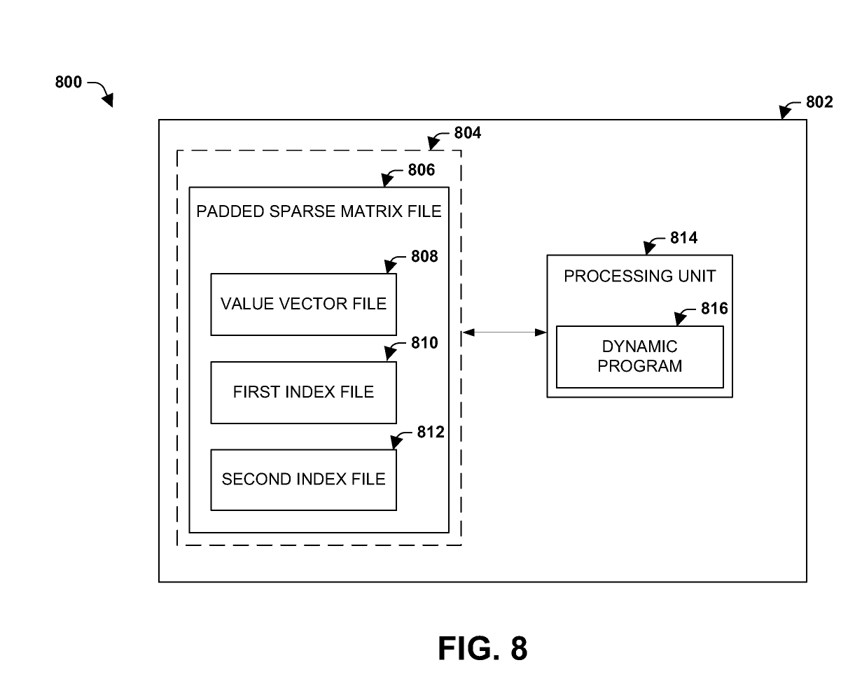

FIG. 8 illustrates a block diagram of an exemplary computer system 802 configured to implement a numeric routine upon a padded compressed storage file format (e.g., PCSR, PCSC) of a sparse matrix as provided herein. As illustrated in FIG. 8, a storage element 804 may be configured to store a sparse matrix file 806. The sparse matrix file may be stored as one or more files comprising a value vector 808, a first index file 810, and a second index file 812. The value vector 808, the first index file 810, and the second index file 812 cumulatively describe the elements of a padded sparse matrix as provided herein. In other words, the value vector 808 comprises lines having a multiple of a predetermined even number n of elements (e.g., zero elements and non-zero elements), wherein the predetermined even number n is based upon an n-fold loop unrolling function (e.g., where n=2^{m}, where m is an integer value), wherein the zero-elements are configured at any location (e.g., at the gaps between) of respective lines (e.g., rows, columns) of a sparse matrix (e.g., wherein the lines are defined by the first index file 810 or the second index file 812). In one example, the predetermined even number n may be determined by empirical testing to enhance code performance.

A processing unit 814 comprising a dynamic program 816 may be configured to operate upon the sparse matrix file 806. The dynamic program 816 may be configured to operate a sparse matrix linear algebra solver and/or key sparse linear algebra kernels (e.g., Sparse matrix vector multiply) on the data comprised within the value vector, for example. Due to the padded sparse matrix file format, the exemplary computer system 802 offers improved overall performance (e.g., running an application) over computer systems utilizing non-padded sparse matrix files.

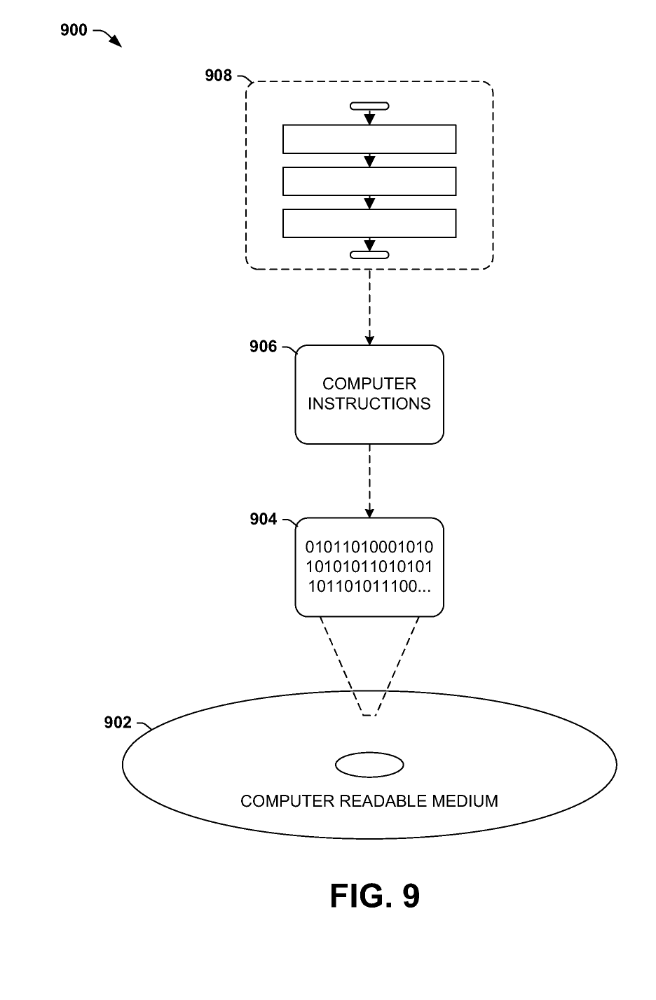

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 902 (e.g., a CD-R, DVD-R, or a platter of a hard disk drive), on which is encoded computer-readable data 904. This computer-readable data 904 in turn comprises a set of computer instructions 906 configured to operate according to one or more of the principles set forth herein. In one such embodiment 900, the processor-executable instructions 906 may be configured to perform a method 908, such as the exemplary method 300 of FIG. 3, for example. In another such embodiment, the processor-executable instructions 906 may be configured to implement a system, such as the exemplary system 800 of FIG. 8, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

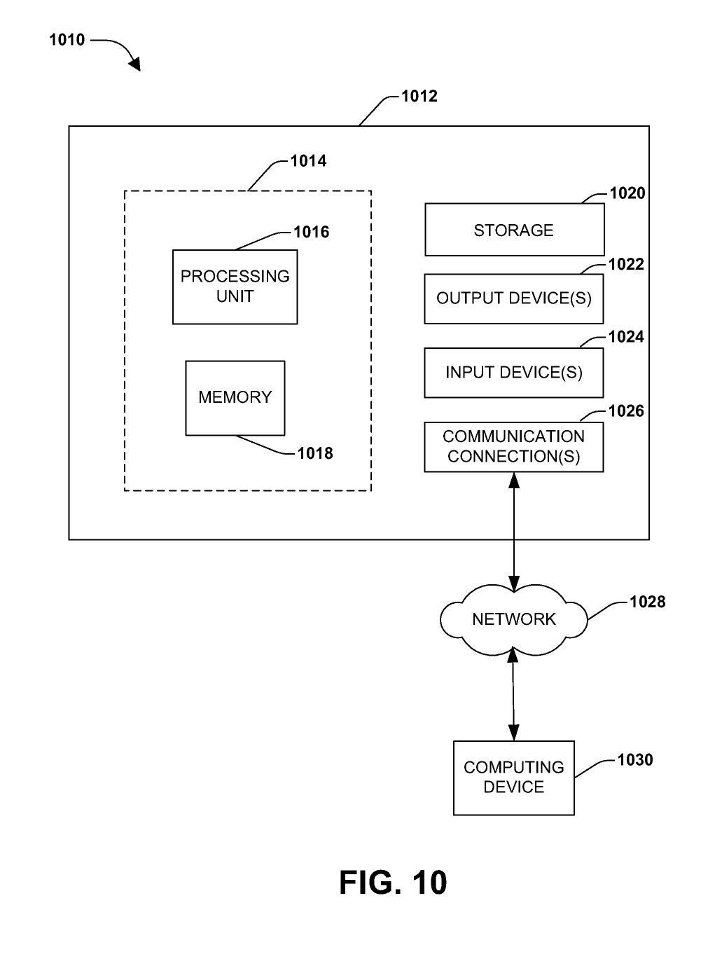

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport component and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for padding a compressed storage file of a sparse matrix, comprising:
selectively inserting one or more zero elements to a line of non-zero elements comprised within the sparse matrix so that a number of elements in respective lines are a multiple of a predetermined even number that is a function of an n-fold unrolling loop.

2. The method of claim 1, comprising forming a value vector comprising the zero elements and the non-zero elements of the sparse matrix.

3. The method of claim 2, the predetermined even number equal to or greater than the predetermined even number used for n-fold loop unrolling.

4. The method of claim 2, the predetermined even number determined by empirical testing.

5. The method of claim 2, the line comprising a row of the sparse matrix, and the n-fold unrolling loop configured to operate on a padded CSR file format.

6. The method of claim 5, comprising inserting a number of column index vector elements into a column index vector which respectively comprise column numbers of the zero elements inserted to the value vector, the number of inserted column index vector elements equal to a number of zero elements inserted to the value vector.

7. The method of claim 6, comprising updating a row index vector to enable respective row index vector elements to comprise a new starting or ending address of respective rows in the value vector and the column index vector.

8. The method of claim 2, the line comprising a column of the sparse matrix, and the n-fold unrolling loop configured to operate on a padded CSC file format.

9. The method of claim 8, comprising inserting a number of row index vector elements into a row index vector which respectively comprise row numbers of the inserted zero elements in the value vector, the number of inserted row index vector elements equal to a number of zero elements inserted to the value vector.

10. The method of claim 9, comprising updating a column index vector to enable respective column index elements to point to a new starting or ending address of respective columns in the value vector and the row index vector.

11. A padded compressed storage file format of a sparse matrix, comprising:
a padded sparse matrix file configured to store a value vector comprising non-zero elements and inserted zero elements, the inserted zero elements located at positions not occupied by the non-zero elements;
wherein a number of elements in respective lines of the sparse matrix is a multiple of a predetermined even number that may be used for loop unrolling.

12. The file format of claim 11, the predetermined even number comprising one of: 2^{m}, wherein m is an integer value.

13. The file format of claim 2, the predetermined even number determined by empirical testing.

14. The file format of claim 12, the respective lines comprising a sparse matrix row, and the loop unrolling configured to operate on a padded CSR file format.

15. The file format of claim 14, the padded sparse matrix file comprising a column index vector having a number of column index vector elements equal to a number of inserted zero elements in the value vector, column index vector elements configured to respectively comprise column numbers of the inserted zero elements in the value vector.

16. The file format of claim 15, the padded sparse matrix file comprising a row index vector having row index vector elements configured to comprise a new starting or ending address of respective rows in the value vector and the column index vector.

17. The file format of claim 12, the respective lines comprising a column of the sparse matrix, and the loop unrolling configured to operate on a padded CSC file format.

18. The file format of claim 17, the padded sparse matrix file comprising a row index vector having a number of padded row index vector elements equal to a number of inserted zero elements in the value vector, the padded row index vector elements indicating row numbers of respective inserted zero elements in the value vector.

19. The file format of claim 18, the padded sparse matrix file comprising a column index vector having column index vector elements configured to point to a new starting or ending address of respective columns in the value vector and the row index vector.

20. A method for padding a compressed storage file of a sparse matrix, comprising:
selectively adding one or more zero elements to a row of non-zero elements comprised within the sparse matrix so that a number of elements in respective rows are a multiple of a predetermined even number, the predetermined even number equal to or greater than an even number that is used for an n-fold unrolling loop configured to operate on a padded CSR file format;
forming a value vector comprising the zero elements and the non-zero elements of the sparse matrix, the zero elements located at positions not occupied by the non-zero elements of the sparse matrix;
inserting a number of column index vector elements into a column index vector which respectively indicate column numbers of the zero elements inserted into the value vector, the number of inserted column index vector elements equal to a number of zero elements inserted into the value vector; and
updating a row index vector to enable respective row index vector elements to point to a new starting or ending address of respective rows in the value vector and the column index vector.
